(19) United States
(12) Patent Application Publication
(10) Pub. No.: US 2013/0054580 A1
(43) Pub. Date: Feb. 28, 2013

(54) Data Point Dictionary

(71) Applicants: Gregory Lee Sewell, Moody, AL (US); Matthew Stephen Wilson, Birmingham, AL (US); Gregory Ansel Edwards, Springville, AL (US)

(72) Inventors: Gregory Lee Sewell, Moody, AL (US); Matthew Stephen Wilson, Birmingham, AL (US); Gregory Ansel Edwards, Springville, AL (US)

(73) Assignee: SOUTHERN COMPANY SERVICES, INC., Atlanta, GA (US)

(21) Appl. No.: 13/222,339

(22) Filed: Aug. 31, 2011

(51) Int. Cl. G06F 17/30

(52) U.S. Cl. 707/723; 707/769; 707/E17.014

(57) ABSTRACT

Disclosed are various embodiments for generating a data hierarchy for ordering a collection of data values and tracking a consumption pattern for each of the data values. In one embodiment, a data service generates a data hierarchy according to a plurality of attributes associated with each of the data values, where the data service determines a classification system for generating the hierarchy based on the attributes. The data service may receive a request for accessing a subset of the complete collection of data values. In response, the data service may generate a data profile that includes the subset of requested data values and provides the data profile to the requesting service. The data service may then determine a consumption profile that describes how the requesting service consumes the subset of data values in the data profile and associate the consumption profile with the consumed data values.

### BACKGROUND

Data may be presented in varying structures such as, for instance, a look-up table, an array, a linked list, and/or any other structure for presenting the data. Applications and users may utilize the data by traversing all of the data values in the entire structure to identify and read the desired data value.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of networked environment according to various embodiments of the present disclosure.

FIG. 2 is a drawing of an example of a data hierarchy generated by a data service executed in a computing device in the networked environment of FIG. 1 according to various embodiments of the present disclosure.

FIG. 3 is a flowchart illustrating one example of functionality implemented as portions of data service executed in a computing device in the networked environment of FIG. 1 according to various embodiments of the present disclosure.

FIG. 4 is a schematic block diagram that provides one example illustration of a computing device employed in the networked environment of FIG. 1 according to various embodiments of the present disclosure.

### DETAILED DESCRIPTION

Disclosed are various embodiments for generating a data hierarchy and tracking usage characteristics of the data values that comprise the data hierarchy. In one embodiment, a data service generates a data hierarchy for ordering a complete collection of data according to a classification system. For instance, the data service may determine the classification system based on a plurality of attributes associated with each of the data values. The data service may then receive a request from a requesting service for accessing a subset of the complete collection of data. For instance, the requested subset of the data may share a plurality of attributes. In response, the data service may then generate a data profile comprising the requested subset and provide the data profile to the requesting service. Further, the data service may then generate a consumption indicator that describes a consumption pattern for each of the data values of the requested subset based at least in part on a usage indicator provided by the requesting service. The consumption indicator may then be interpreted to track how each of the data values is used. In the following discussion, a general description of the system and its components is provided, followed by a discussion of the operation of the same.

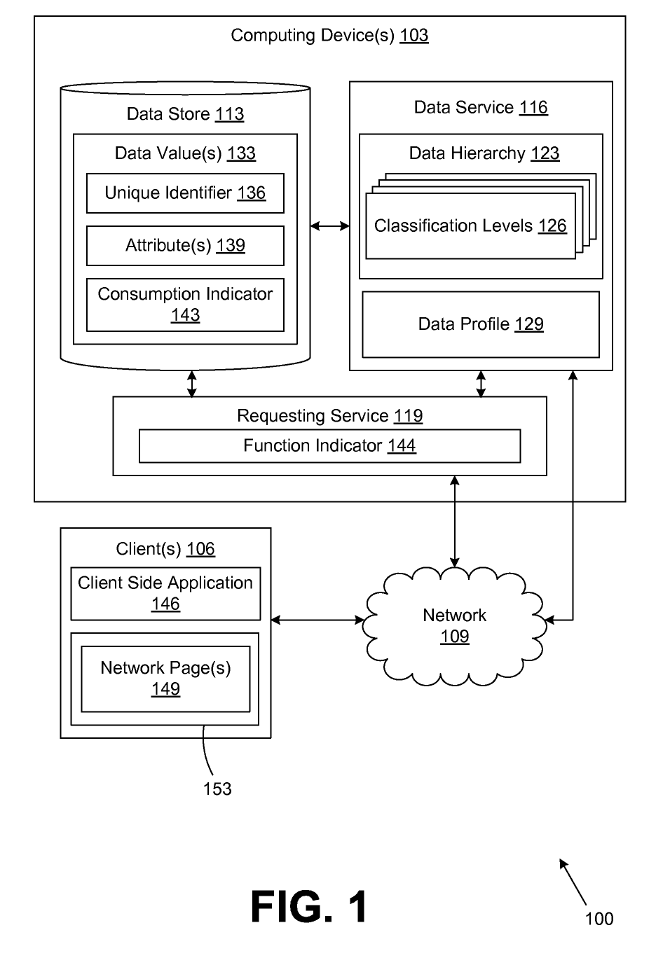

With reference to FIG. 1, shown is a networked environment 100 according to various embodiments. The networked environment 100 includes a computing device 103, a client 106, and a network 109. The network 109 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device is referred to in the singular, it is understood that a plurality of computing devices 103 may be employed in the various arrangements as described above.

Various applications and/or other functionality may be executed in the computing device 103 according to various embodiments. Also, various data is stored in a data store 113 that is accessible to the computing device 103. The data store 113 may be representative of a plurality of data stores as can be appreciated. The data stored in the data store 113, for example, is associated with the operation of the various applications and/or functional entities described below.

The components executed on the computing device 103, for example, include a data service 116, a requesting service 119, and other applications, services, processes, systems, engines, or functionality not discussed in detail herein. The data service 116 is executed to generate an ordered data hierarchy 123 comprising data values 133 from the data store 113. In one embodiment, the data hierarchy 123 comprises a plurality of classification levels 126 that indicates the order of the data values 133 in the data hierarchy 123. In addition, the data service 123 is executed to generate a data profile 129 comprising a subset of the data in the hierarchy 129, as will be described. Additionally, the requesting service 119 is executed to transmit a request to the data service 116 to access a relevant subset of the data in the hierarchy 123 and receive a data profile 129 that includes the relevant subset of the data, as will be described. Further, the requesting service 119 is configured to generate a function indicator 144 for describing a function and/or purpose for consuming the data values 133 in the data profile 129.

The data stored in the data store 113 includes, for example, information stored for each data values 133, and potentially other data. The information stored for each data value 133 includes a unique identifier 136, a plurality of attributes 139, a consumption indicator 143, and potentially other information. In one embodiment, the unique identifier 136 uniquely identifies the respective data value 133, such as, for instance, by identifying the data value 133 according the classification levels 126 under which the data value 133 falls in the data hierarchy 123.

In one embodiment, the attributes 139 describe the data value 133 to provide appropriate context and meaning to the data value 133. For instance, assuming the data value 133 is a number, the attributes 139 associated with the data value 133 may indicate that the data value 133 is a measurement, a metric described by the measurement, a location indicating where the metric was measured, a time indicating when the metric was measured, and/or any other attribute associated with the data value 133. As an example, a data value 133 may represent a measurement such as, for instance, a power output of a power facility. Associated with the data value 133 representing the power output may be a plurality of attributes 139 such as, for instance, a name of the power facility, a name of a power generator operating in the power facility, a geographic region being serviced by the power generator, a date and time the measurement was taken, and/or any other attribute 139 of the data value 133. In addition, other attributes 139 may also include a category of measurement, a data category of the data value 133, and/or any other relevant attribute 139 of the data value 133. For example, the attributes 139 may indicate a type of measurement, such as, for instance, generation, load, mode, status, fuel, and/or any other type of measurement.

In addition, the consumption indicator 143 describes a consumption of the data value 133 by the requesting service 119 and/or any other application, as will be described. For instance, the data value 133 may be provided to the requesting service 119 and the consumption indicator 143 may describe how the requesting service 119 was consumed by the requesting service 119. In another embodiment, the consumption indicator 143 may be represented by a name of the requesting service 119 that consumes the data value 133, a listing of names of a plurality of other applications called to execute by the requesting service 119 for consuming the data value 133, and/or names of any other services that consume the data value 133.

The client 106 is representative of a plurality of client devices that may be coupled to the network 109. The client 106 may comprise, for example, a processor-based system such as a computer system. Such a computer system may be embodied in the form of a desktop computer, a laptop computer, a personal digital assistant, a cellular telephone, set-top box, music players, web pads, tablet computer systems, game consoles, or other devices with like capability.

The client 106 may be configured to execute various applications such as a client side application 146 and/or other applications. The client side application 146 may be executed in the client 106, for example, to access and render network pages, such as web pages, or other network content served up by the computing device 103 and/or other servers. To this end, the client side application 146 may comprise, for example, a browser application or a similar application. When executed in the client 106, the client side application 146 renders network pages 149 on the display 153. The client 106 may be configured to execute applications beyond client side application 146 such as, for example, email applications, instant message applications, and/or other applications.

Next, a general description of the operation of the various components of the networked environment 100 is provided. A user on a client 106 may transmit a request to the requesting service 119 for accessing a subset of the complete collection of data values 133 for consumption upon an execution of the client side application 146, and/or any other application. For instance, a user may request to access a subset of the data values 133 by interacting with the requesting service 119 through a network page 149 rendered on a display 153 associated with the client 106. In another embodiment, the requesting service 119 may originate the request to access the subset of the data values 133. The requesting service 119 may then interface with the data service 116 to access the requested subset of the data values 133. In response to the receiving the request for access, the data service 116 may generate a data profile 129 comprising the requested subset of data values 133, where the data profile 129 is provided to the requesting service 119 as a portion of a singular ordered structure according to the data hierarchy 123, as will be described. The requesting service 119 may then subsequently consume and/or process the subset of data values 133 in the data profile 129, and provide a description of the planned usage for the data service 116. Upon receiving the description of the usage from the requesting service 119, the data service 116 then associates the description with each of the data values 133 in comprising the data profile 129, as will be described. In one embodiment, the data service 116 may track the usage of each of the data values 133 once accessed by a requesting service 119 and/or any other application.

To begin, the data service 116 first generates a singular data hierarchy 123 that comprises a complete collection of the data values 133. In one embodiment, the data service 116 may generate an ordered tree, a hierarchical tree structure, any other ordered structure comprising linked nodes, and/or any other type of data hierarchy 123. For instance, the data service 116 may generate the data hierarchy 123 upon receiving a first request for accessing a subset of the complete collection of the data values 133. In another embodiment, the data service 116 may generate the data hierarchy 123 upon receiving every request for accessing the subset of the data values 133. In yet another embodiment, the data service 116 may generate the data hierarchy 123 at any other frequency, such as, for instance, periodically over a predetermined period of time, as requested by the requesting service 119 or another application, and/or any other frequency.

To generate the data hierarchy 123, the data service 116 may first determine a plurality of classification levels 126 for ordering the entire collection of data values 133. In one embodiment, the data service 116 determines the classification levels 126 based at least in part on the attributes 139 associated with each of the data values 133. For instance, the attributes 139 associated with the data values 133 describe the data value 133 to provide appropriate context and meaning to the data value 133, as described above. In one embodiment, the types and categories of attributes 139 may be predetermined by the data service 116 and/or any other service.

Additionally, the data service 116 may determine the classification levels 126 based at least in part on a ranking of the attributes 139 that may be associated with each of the attributes 139. In one embodiment, the ranking may indicate a taxonomy of attributes 139. For instance, the ranking may be of a sufficient granularity such that the attributes 139 may be ranked and/or classified relative to each other. In one embodiment, the ranking may further indicate a plurality of supertype-subtype relationships of the attributes 139 relative to each other. Using the above example of a power facility, the ranking associated with each of the attributes 139 may indicate that the name of the power facility is the broadest supertype of the attributes 139, followed by the name of a power generator, the geographic region, and the date and time of the measurement, respectively. In this example, the data service 116 may use the names of all of the power facilities referenced by the data values 133 to serve as the broadest classification level 126 for the data hierarchy 123.

Next, the data service 116 may then determine the remaining classification levels 126 of the data hierarchy 123 based on the ranking of the attributes 139. For instance, referring to the above example, the data service 116 may determine that the names of the power generators are the next broadest classification according to the rankings of the attributes 139. As such, the data service 116 determines that the names of the power generators are the second broadest classification level 126 for the data hierarchy 123. Thus, the data service 116 determines that the second broadest classification level 126 corresponds to the second broadest supertype, i.e. the names of the power generators. In one embodiment, the data service 116 may use a substantially similar approach to determine the remaining classification levels 126 of the data hierarchy 123. Having determined the classification levels 126 of the data hierarchy 123, the data service 116 may then populate the data hierarchy 123 with the complete collection of data values 133, as can be appreciated.

Upon populating the data hierarchy 123, the data service 116 may associate each data value 133 in the complete collection of data values 133 with a unique identifier 136 based at least in part on the classification levels 126 of the data hierarchy 123. In one embodiment, the data service 116 determines the unique identifier 136 based on each of the classification levels 126 under which the data value 133 falls. For instance, using the example from above, the data service 116 may determine that the unique identifier 136 for each of the data values 133 represents the name of the power facility, the name of one of the generators, the geographic area being serviced, and the date and time of the measurement. In one embodiment, the unique identifier 136 may be represented by a plurality of bit fields, such as, for instance, a plurality of bits representing a power generation facility, a plurality of bits representing a name of a power generator, a plurality of bits representing a geographic area serviced by the power generator, and/or any other classification levels 126 to which the data value 133 is associated.

Next, the data service 116 may determine the subset of the data values 133 to which access was requested by the requesting service 119 and create the data profile 129. In one embodiment, the requesting service 119 may identify the desired subset of data values 133 by the attributes 139, the classification levels 126, the unique identifiers 136 of the data values 133 in the subset, and/or any other manner. For instance, using the example from above, the requesting service 119 may describe the desired subset of data values 133 by attributes 139 such as, for instance, an output power of all power generators measured on a specific day or range of days. In another embodiment, the user on the client 106 may indicate the attributes 139 of the desired subset of data values 133 on a network page 149, as can be appreciated. The data service 116 may then determine the classification levels 126 that correspond to the requested attributes 139. Using the above example, the data service 116 identifies the classification level 126 that corresponds with the specified day and designates the data values 133 that are associated with the identified classification level 126 for creating the data profile 129. In one embodiment, the data service 116 determines the subset of the data values 133 by traversing the data hierarchy 123 through the classification levels 126 to identify the power outputs of each power generator at every power facility on the specified day. The data service 116 then prepares a data profile 129 that includes only the identified subset of data values 133 and provides the data profile 129 to the requesting service 119. For instance, the data profile 129 may be only a portion of the singular data hierarchy 123 represented by a plurality of unique identifiers 136 and/or classification levels 126.

Having received access to the data profile 129, the requesting service 119 then consumes the subset of data values 133 included in the data profile 129. In one embodiment, the requesting service 119 may consume the subset of data values 133 by reading and/or otherwise processing the data values 133 as can be appreciated. Further, the requesting service 119 may call to execute a plurality of other applications that may consume the subset of data values 133 provided in the data profile 129. In another embodiment, the requesting service 119 may store the data profile 129 in a cache memory accessible to the requesting service 119, the data store 113, and/or any other memory accessible to the requesting service 119. For instance, the requesting service 119 may store the data profile 129 for accessing and/or consuming at a later time.

In consuming the subset of data values 133 in the data profile 129, the requesting service 119 may generate a function indicator 144. For instance, the requesting service 119 may generate the function indicator 144 to indicate that a specific data value 133 in the subset of data values 133 of the data profile 129 was consumed. In addition, the requesting service 119 may generate the function indicator 144 to indicate a name of the requesting service 119 that consumed the respective data value 133 and/or names of other applications called to execute by the requesting service 119 for consuming the respective data value 133. In another embodiment, the requesting service 119 may generate the function indicator 144 to indicate a function and/or purpose for consuming each of the data values 133 of the data profile 129. For example, the requesting service 119 may determine the purpose and/or function of the executed applications from a metadata associated with the applications as can be appreciated. Using the example from above, the requesting service 119 may determine that the power outputs for all the power generators of a specific power generator facility are being requested to determine an average power output over a period of days. For instance, the requesting service 119 may call to execute an average determination application to determine the average power. In one embodiment, the requesting service 119 may generate the function indicator 144 to indicate the name of the average determination application and/or a function of the average determination application based on a metadata associated with the average determination application.

In a further embodiment, the requesting service 119 may generate the function indicator 144 prior to consuming the data values 133 of the data profile 129. For instance, the requesting service 119 may generate the function indicator 144 based on a plurality of other applications that may be called for execution by the requesting service 119 for consuming the data values 133 of the data profile 129. The requesting service 119 may generate the function indicator 144 to indicate the name of the application that will be called to execute and a function of the application that will be called to execute, as described above.

Upon generating the function indicator 144, the requesting service 119 may then provide the function indicator 144 to the data service 116. In one embodiment, the data service 116 may determine the consumption indicator 143 based on the function indicator 144 generated by the requesting service 119. For instance, the data service 116 may determine the consumption indicator 143 for each of the data values 133 in the subset of data values 133 comprising the data profile 129 based on the function indicator 144 generated by the requesting service 119 upon consumption of the respective data value 133 of the data profile 129. In one embodiment, the consumption indicator 143 determined by the data service 116 may be substantially similar to the function indicator 144 generated by the requesting service 119. In another embodiment, the data service 116 may include the function indicator 144 generated by the requesting service 119 to be a portion of a previously determined consumption indicator 143. For instance, the consumption indicator 143 may have been determined on a previous instance of the data service 116. In this example, the data service 116 may include the function indicator 1146 generated by the current instance of the requesting service 119 to be a portion of the previously determined consumption indicator 143. Thus, the data service 116 determines the consumption indicator 143 that can be leveraged for characterizing and tracking a usage of each of the data value 133 in the data store 113.

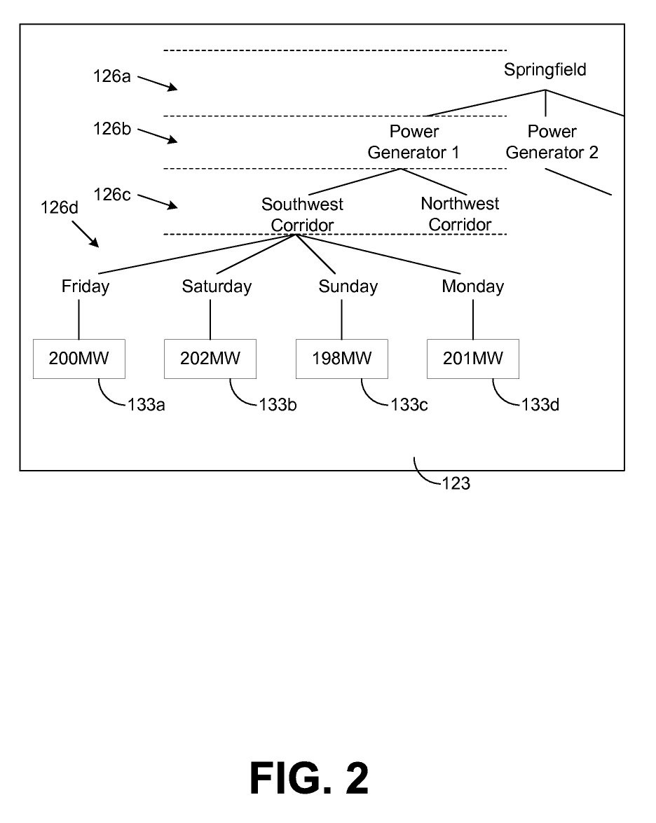

Referring next to FIG. 2, shown is an example of a data hierarchy 123 according to various embodiments of the present disclosure. The various graphical components such as the nodes and pointers shown in FIG. 2 are merely examples of the various types of features that may be used to accomplish the specific purposes noted. In this embodiment, shown is a data hierarchy that may be generated by the data service 116 (FIG. 1) according to various embodiments.

In one embodiment, the data service 116 generates the data hierarchy 123 to be a hierarchical tree structure comprising a plurality of nodes and pointers as shown in FIG. 2. The data hierarchy 123 includes a plurality of classification levels 126 and a plurality of data values 133 associated with the classification levels 126. In one embodiment, the data service 116 determines the classification levels 126 based on a plurality of attributes 139 (FIG. 1) associated with each of the data values 133, as described above. For instance, as shown in FIG. 2, the data service 116 may determine that a broadest classification level 126a is a name of a power generation facility, a second broadest classification level 126b are the names of the power generators located within the power generation facility, a third broadest classification level 126c is a geographic area being serviced by each of the power generators, and the least broadest classification level 126d are the days on which the power was generated. In addition, the data service 116 populates the data hierarchy 123 to include the data values 133a/133b/133c/133d such that they are classified under their respective classification levels 126.

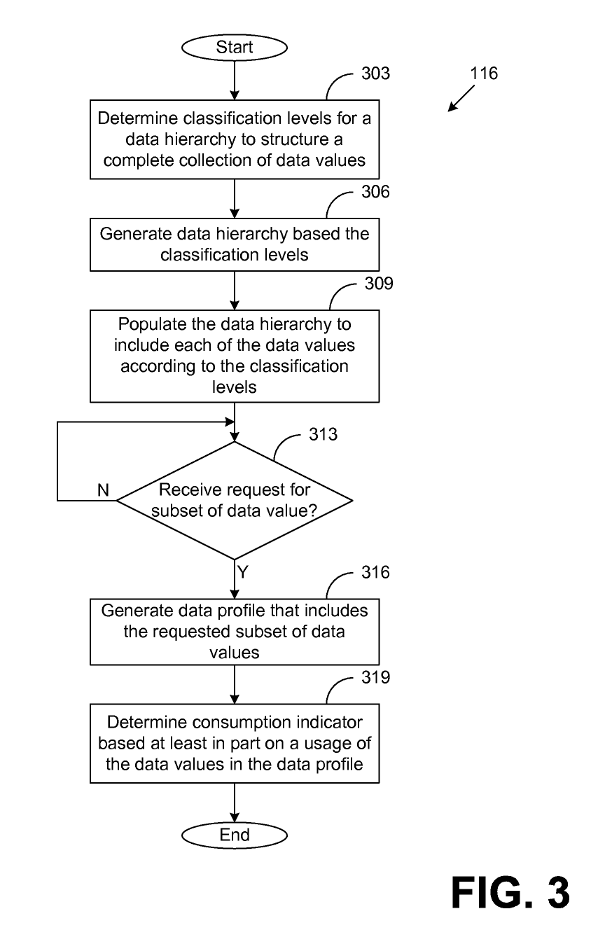

Referring next to FIG. 3, shown is a flowchart that provides one example of the operation of a portion of the data service 116 according to various embodiments. It is understood that the flowchart of FIG. 3 provides merely an example of the many different types of functional arrangements that may be employed to implement the operation of the portion of the data service 116 as described herein. As an alternative, the flowchart of FIG. 3 may be viewed as depicting an example of steps of a method implemented in the computing device 103 (FIG. 1) according to one or more embodiments.

Beginning with box 303, the data service 116 determines a plurality of classification levels 126 (FIG. 1) for generating a data hierarchy 123 (FIG. 1). In one embodiment, the data service 116 may determine the classification levels 126 based at least in part on a plurality of attributes 139 (FIG. 1) associated with each one of a complete collection of data values 133 (FIG. 1) that are to be ordered in the data hierarchy 123. For instance, a ranking may be associated with each of the attributes 139 indicating a taxonomy of the attributes 139 relative to each other, as described above. The data service 116 may determine the classification levels 126 based on the rankings associated with the attributes 139.

Then, in box 306, the data service 116 generates the data hierarchy 123 according to the determined classification levels 126. Next, in box 309, the data service 116 populates the data hierarchy 123 to include the complete collection of data values 133. For instance, each of the data values 133 is associated with a plurality of classification levels 126 that correspond with the attributes 139 of the respective data value 133, as described above.

In box 313, the data service 116 determines if a request for accessing a subset of the complete collection of data values 133 is received. In one embodiment, the data service 116 may receive a request to access the subset of data values 133 from a requesting service 119. For instance, the requesting service 119 may identify the subset of data values 133 being requested by a plurality of attributes associated with the desired subset of data values 133, as described above. The data service 116 determines if a request for the subset of data values 133 is received and proceeds to box 316 if the requested is received. An inactivity timeout period may be associated with the data service 116 in the event that no request for accessing the subset of data values 133 is received.

Next, in box 316, the data service 116 generates a data profile 129 (FIG. 1) that includes the subset of data values 133 requested by the requesting service 119. In one embodiment, the data service 116 generates a data profile 129 to provide to the requesting service 119, as described above. For instance, the data profile 129 may comprise a portion of the data hierarchy 123, where the data profile 129 includes requested subset of data values 133 ordered according to the classification levels 126.

Finally, in box 319, the data service 116 determines a consumption indicator 143 (FIG. 1) for each of the data values 133 included in the data profile 129. In one embodiment, the consumption indicator 143 associated with the data value 133 may describe how the data value 133 is consumed upon being accessed. For instance, the data service 116 may determine the consumption indicator 143 based on a function indicator 144 (FIG. 1) generated by the requesting service 119, as described above. In one embodiment, the requesting service 119 may generate the function indicator 144 to include a function and/or a purpose of an application being called to execute by the requesting service 119 for consuming the data values 133. Further, the data service 116 may include the function indicator 144 as a portion of the consumption indicator 143 for describing the consumption of the respective data value 133.

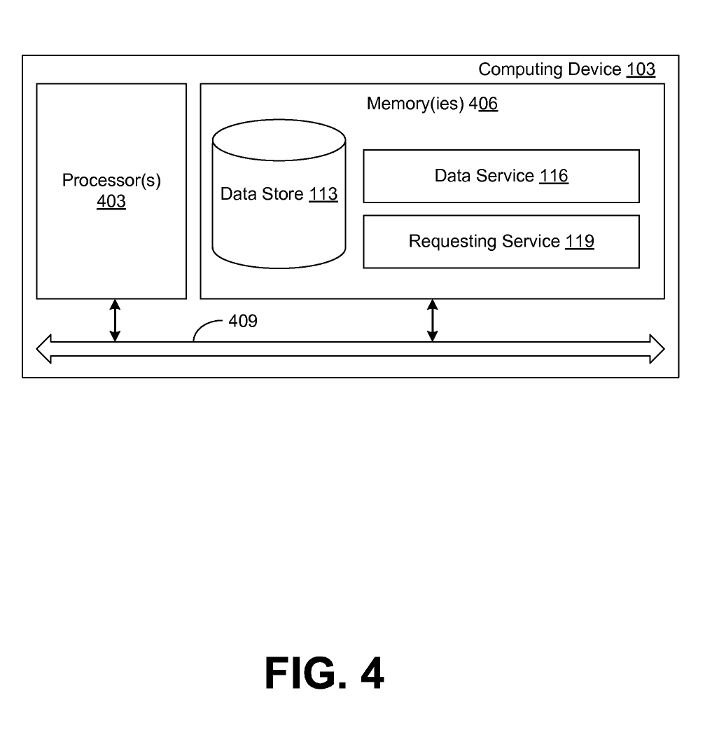

With reference to FIG. 4, shown is a schematic block diagram of the computing device 103 according to an embodiment of the present disclosure. The computing device 103 includes at least one processor circuit, for example, having a processor 403 and a memory 406, both of which are coupled to a local interface 409. To this end, the computing device 103 may comprise, for example, at least one server computer or like device. The local interface 409 may comprise, for example, a data bus with an accompanying address/control bus or other bus structure as can be appreciated.

Stored in the memory 406 are both data and several components that are executable by the processor 403. In particular, stored in the memory 406 and executable by the processor 403 are a data service 116, a requesting service 119, and potentially other applications. Also stored in the memory 406 may be a data store 113 and other data. In addition, an operating system may be stored in the memory 406 and executable by the processor 403.

It is understood that there may be other applications that are stored in the memory 406 and are executable by the processors 403 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403 may represent multiple processors 403 and the memory 406 may represent multiple memories 406 that operate in parallel processing circuits, respectively. In such a case, the local interface 409 may be an appropriate network 109 (FIG. 1) that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403 may be of electrical or of some other available construction.

Although the data service 116, the requesting service 119, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 3 shows the functionality and operation of an implementation of portions of the data service 116. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 403 in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the data service 116 and the requesting service 119, that comprises software or code can be embodied in any non-transitory computer-readable medium for use by or in connection with an instruction execution system such as, for example, a processor 403 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A non-transitory computer-readable medium embodying a program executable in a computing device, the program comprising:
code that generates a data hierarchy for a complete collection of data values, wherein the data hierarchy comprises a plurality of classification levels;
code that determines the classification levels based on a plurality of attributes associated with each of the data values;
code that populates the data hierarchy with the data values according to the classification levels;
code that receives a request from a requesting service for accessing a subset of the complete collection of data values;
code that generates a data profile comprising the requested subset of data values;
code that provides the data profile according to the data hierarchy to the requesting service, wherein the requesting service consumes the data values included the data profile; and
code that determines a consumption indicator for each one of the data values consumed by the requesting service, the consumption indicator indicating a consumption pattern for the respective data value.

2. The computer-readable medium of claim 1, wherein the classification levels are determined based on a ranking associated with each one of the attributes.

3. The computer-readable medium of claim 1, wherein the consumption indicator is determined based on a function indicator generated by the requesting service that indicates a function performed by consuming the data value.

4. A system, comprising:
at least one computing device; and
a data service executable in the at least one computing device, the data service comprising:
logic that generates a data hierarchy having a plurality of classification levels, the data hierarchy configured to order a plurality of data values according to the classification levels based at least on a plurality of attributes associated with each one of the data values;
logic that receives a request from a requesting service for accessing a subset of the data values;
logic that generates a data profile comprising the requested subset of the data values, the data profile being a portion of the data hierarchy;
logic that provides the data profile to the requesting service; and
logic that tracks a usage of the subset of the data values provided in the data profile.

5. The system of claim 4, wherein each data value has a unique identifier based at least in part on the classification levels of the data hierarchy.

6. The system of claim 5, wherein the classification levels indicate a hierarchical organization of the data hierarchy.

7. The system of claim 6, wherein the number of classification levels in the hierarchy corresponds to the number of attributes associated with each of the data values.

8. The system of claim 4, wherein each data value is associated with a consumption indicator, the consumption indicator comprising a description of a consumption of the data value.

9. The system of claim 8, wherein the consumption indicator comprises at least one of a name of a service consuming the data value, and a purpose for consuming the data value.

10. The system of claim 8, wherein the consumption indicator is determined from a function indicator provided by the requesting service.

11. The system of claim 10, wherein the requesting service generates a function indicator based at least on a function performed while consuming the data value in the data profile.

12. The system of claim 5, wherein the unique identifier of each one of the data values represents the classification levels associated with the respective data value.

13. The system of claim 4, wherein the classification levels are determined based on a ranking associated with each one of the attributes.

14. A method, comprising the steps of:
requesting, by a client device, to access a plurality of data values, the data values being a subset of a complete collection of data ordered in a data hierarchy, wherein a request to access the plurality of data values describes the subset of the complete collection by attributes associated with the data values, wherein the subset of the complete collection of data is determined to correspond to a classification level of the complete collection of data values that further corresponds to the requested attributes;
receiving the requested data values from a data service;
consuming the requested data values; and
generating a function indicator for indicating a function performed by consuming the each one of the requested data values.

15. The method of claim 14, wherein the data hierarchy comprises a plurality of classification levels, each of the levels corresponding to an attribute of data values comprising the collection of data.

16. The method of claim 15, wherein each data value has a unique identifier based at least in part on the classification levels of the data hierarchy.

17. The method of claim 15, wherein the number of classification levels corresponds to the number of attributes associated with the data values.

18. The method of claim 14, further comprising the step of providing the function indicator to a data service to determine a consumption profile of each of the requested data values.

19. The method of claim 14, wherein the function indicator comprises at least one of a name of the requesting service, and a function performed by consuming the data value.

20. The method of claim 15, wherein the classification levels are determined based at least on a ranking associated with each of the attributes.
